(19) United States
(12) Patent Application Publication
(10) Pub. No.: US 2014/0010202 A1
(43) Pub. Date: Jan. 9, 2014

(54) MANAGING LINK LAYER RESOURCES FOR MEDIA INDEPENDENT HANDOVER

(71) Applicants: Pedro Miquel Maia Neves, Aveiro (PT); George P. Lampropoulos, Samos (GR); Skianis Charalabos, Samos (GR); Alvro Henrique Da Conceicao Gomes, Aveiro (PT); Sarakis Lambros, Aghia Paraskevi (GR); George Kormentzas, Aghia Paraskevi (GR); Kontovasilis Kimon, Aghia Paraskevi (GR)

(72) Inventors: Pedro Miquel Maia Neves, Aveiro (PT); George P. Lampropoulos, Samos (GR); Skianis Charalabos, Samos (GR); Alvro Henrique Da Conceicao Gomes, Aveiro (PT); Sarakis Lambros, Aghia Paraskevi (GR); George Kormentzas, Aghia Paraskevi (GR); Kontovasilis Kimon, Aghia Paraskevi (GR)

(73) Assignees: PORTUGAL TELECOM INOVACAO S.A., Aveiro (PT); UNIVERSITY OF AEGEAN, Samos (GR); NATIONAL CENTRE FOR SCIENTIFIC RESEARCH "DEMOKRITOS", Aghia Paraskevi (GR)

(21) Appl. No.: 13/814,143

(22) PCT Filed: Aug. 4, 2011
(86) PCT No.: PCT/PT2011/000026

§ 371 Date: Jun. 11, 2013

(30) Foreign Application Priority Data
Aug. 4, 2010 (PT) PT 105235

(51) Int. Cl. H04W 36/30

(52) U.S. Cl. CPC H04W 36/30
USPC 370/331

(57) ABSTRACT

A method for managing radio resources in the radio access technologies during a handover procedure by proposing new commands primitives for the IEEE 802.21 framework. The primitives allow an application level entity, such as a Quality of Service (QoS) Manager, to enforce radio resources allocation and deletion in the access technologies, either locally or remotely, as well as to receive event notifications from the link layer technologies with the resources reservation and/or deletion result.

### FIELD OF THE INVENTION

The present invention concerns a mechanism for managing radio resources in the serving and target access technology during a handover procedure by proposing new signaling messages for the IEEE 802.21 framework.

### BACKGROUND OF THE INVENTION

### Seamless Mobility

Broadband Wireless Access (BWA) technologies are expected to play a central role in Next Generation Networks (NGN). WiMAX, 3GPP UMTS/LTE, Wi-Fi and DVB are examples of such technologies that have the potential to form the foundation upon which operators will deliver ubiquitous Internet access in the near future, greatly benefiting from existing and future infrastructures. However, true seamless connectivity is yet to be offered in heterogeneous network environments where Mobile Nodes (MNs) change between different wireless technologies. The issue of handover is becoming more important if other parameters such as handover experience by the user, Quality-of-Service (QoS), security and unified authentication are taken into account.

In order to facilitate handover between different access technologies, IEEE has established the “Media Independent Handover (MIH) Services Working Group (IEEE 802.21 WG)” and specified within this group the respective standard. The last introduces a new Layer 2.5 (L2.5) protocol that combines functionality from different access technologies into a set of generic commands, events and information services. Efficient use of this set of services for each technology requires proper translation to specific link layer messages.

Another important aspect that must be fulfilled in a seamless mobility procedure is the support of Quality of Service (QoS) mechanisms. Seamless mobility requires the active support of QoS related mechanisms during the handover preparation process, guaranteeing that resources are available in the target access network before mobility management operations are completed. In other words, mobility management and QoS processes are fundamental for a seamless handover procedure and must not be dissociated.

### MIH Reference Framework

The IEEE 802.21 standard aims to optimize the mobility management procedures in heterogeneous access environments. Towards this aim, it defines the MIH framework, which provides standardized interfaces between the access technologies and the mobility protocols from the higher layers in the protocol stack. The envisaged heterogeneous environment is illustrated in FIG. 1.

A multi-operator, multi-technology network employing WiMAX, Wi-Fi and 3GPP LTE access technologies is shown, including the IEEE 802.21 MIH Point of Attachment (PoA) and Point of Service (PoS). In order to exchange MIH signalling between peers, specific roles have been assigned to network nodes according to the IEEE 802.21 framework. The PoA is the access technology attachment point (e.g. WiMAX Base Station, Wi-Fi Access Point, 3GPP LTE eNodeB), whereas the PoS is a network-side Media Independent Handover Function (MIHF) instance that exchanges MIH messages with a multimode MN based MIHF. Initially and before the handover, the MIHF entity in the MN is directly connected to a peer MIHF entity in a network node (MIH PoS). The PoS can be located either at the network Point-of-Attachment (PoA) with which the MN has an active L2 connection (serving PoA) or deeper in the network. When handover occurs, available PoAs are evaluated (candidate PoAs) and the final one is selected (target PoA).

Furthermore, different PoS may be chosen to offer MIH services to the MN.

Furthermore, on the right-side of FIG. 1 is also illustrated the MIH Information Server (IS) which stores static information about the operator available access networks. Further details about the MIH IS and its operation will be provided later.

### MIH Services

The key concept of the IEEE 802.21 standard is to provide a mechanism for performing Vertical Handover (VHO) independently of the underlying access network technologies. In the “heart” of this mechanism resides the Media Independent Handover Function (MIHF), a logical entity placed between the device interfaces (technology specific link layers) and the MIH User (MIHU) that represents the upper layers (Layer-3—L3 and above). Several MIH Users can benefit from the MIH framework, including mobility management protocols, such as Fast Mobile IPv6 (FMIPv6), Proxy Mobile IPv6 (PMIPv6) and Session Initiation Protocol (SIP), as well as the other mobility decision algorithms. Such an entity, as depicted in FIG. 2, can be located both at the mobile and at the network nodes.

In order to detect, prepare and execute the vertical and horizontal handovers, the MIH platform provides the following set of services:
1. Media Independent Event Service (MIES);
2. Media Independent Command Service (MICS);
3. Media Independent Information Service (MIIS).

The Media Independent Event Service (MIES) provides event reporting such as dynamic changes in link conditions, link status and link quality. The events may be either local or remote and they may originate from MAC, PHY of MIH Function either at the Mobile Node (MN) or at the network point of attachment (PoA). Multiple higher layer entities may be interested in these events at the same time, so these events may need to be sent to multiple destinations.

IEEE 802.21 defines two types of events: link events and MIH events. Link events originate from the lower layers and then are propagated by the MIHF to registered MIHUs. Events that propagate from the MIHF to the MIHUs are called MIH events. MIH events may be local or remote. Local MIH events may be propagated across different layers within the local protocol stack, whereas the remote MIH events traverse across the network to a peer MIHU (see FIG. 3).

The Media Independent Command Service (MICS) enables MIHUs to control the physical, data link and logical link layer. The higher layers may utilize MICS to determine the status of links and/or control a multimode terminal. Furthermore, MICS may also enable MIHUs to facilitate optional handover policies. Events and/or Commands can be sent to MIHUs within the same protocol stack (local) or to MIHUs located in a peer entity (remote).

The commands are classified in two categories: MIH commands and link commands. MIH commands originate from the higher layer(s) addressing the MIHF, and they may be local or remote. Local MIH commands are sent by higher layers to the MIHF in the local protocol stack. Remote MIH commands are sent by higher layers to a MIHF in the peer stack. Link commands originate from the MIHF and sent to the link layers. These commands mainly control the behaviour of the link layer entities (see FIG. 4).

The Media Independent Information Service (MIIS) provides a framework by which a MIHF located at the Mobile Node or at the network side may discover and obtain network information within a geographical area to facilitate handovers. The objective is to acquire a global view of all the heterogeneous networks in the area in order to optimize seamless handovers when roaming across these networks. FIG. 5 illustrates the MIIS service.

All aforementioned services use standard Service Access Points (SAPs) for message exchange. More specifically, the MIH_SAP is used for communication between the MIH User and the MIHF, and the MIH_LINK_SAP handles MIH signaling exchange between the MIHF and the technology specific link layers. Communication between peer MIH entities (often used by the MIIS) takes place over the MIH_NET_SAP.

### MIH Seamless Mobility Procedure Overview

In order to clarify the target of this invention and better depict the problem statement, a high-level description of a mobile initiated seamless mobility procedure, optimized with the IEEE 802.21 Media Independent Handover framework, is provided below. The handover procedure is split into four phases: initiation, preparation, execution and completion.

Handover Initiation

Initially, the MN is connected to the Serving Access Network (SAN) and exchanges traffic with another node in the Internet. Any new application defining QoS requirements at the upper layers results in configuration of the serving access network thresholds, for which the link layer will report measurements to the MIH layers. This is done using MIH_Link_Configure_Thresholds [MIH_SAP] messages. After successful link threshold configuration, the MN waits for any measurement report from the serving link layer that is generated periodically. These reports are transferred from the serving access network MAC to the MIHF (Link_Parameters_Report.indication [MIH_LINK_SAP]) and from the MIHF to the MIHU through the MIH_Link_Parameters_Report.indication [MIH_SAP]. In case any measurement reports indicate a severe QoS degradation at the MN, an imminent handover is expected. This estimation report is transferred from the link layer through Link_Going_Down.indication [MIH_LINK_SAP] to MIHF and further to the MIHU with a MIH_Link_Going_Down.indication [MIH_SAP]. FIG. 6 illustrates the aforementioned procedure.

Handover Preparation

Immediately after receiving MIH_Link_Going_Down.indication [MIH_SAP], the MN starts searching for a Candidate Access Network (CAN). The MIHU retrieves information about the neighboring networks by querying the MIIS Information Server (with the MIH_Get_Information messages), as depicted in FIG. 7. The IS returns the candidate networks Point of Attachments (PoAs) near the MN, along with their characteristics. The last information is quite useful because it can help the MN later scan specific radio networks rather than every available candidate network.

The MN also identifies the resource availability status of the candidate access networks by sending the MIH_MN_HO_Candidate_Query.request message to the serving access network. When the serving Point of Service (PoS) receives the MIH_MN_HO_Candidate_Query.request from the MN, it retrieves resource information from candidate networks by sending MIH_N2N_HO_Query_Resources message to the respective candidate PoSs. The candidate access networks, in turn, use MIH_Link_Get_Parameters.request/confirm [MIH_SAP] to check for available resources and the serving access network sends a respond with all the resource availability information to the MIHU with MIH_MN_HO_Candidate_Query.confirm. The resources availability check procedure is depicted in FIG. 8.

Based on resource availability check, scanning results and other network information retrieved earlier from the IS Server, the candidate access network (CAN_{—}1) is selected as the Target Access Network (TAN) for handover by the MN. Right after this decision, any other interface previously powered on for scanning is now ordered to power off. The handover decision also enables a MIH_Link_Actions.request/confirm (POWER_UP) [MIH_SAP] message exchange in order to establish L2 connectivity with the selected access network.

Thereafter, the MN sends MIH_MN_HO_Commit.request message to the serving access network to notify it about the decided target network information. In turn, the resources reservation process at the target access network is initiated through MIH_N2N_HO_Commit messages. When the MIHU@TAN receives the MIH_N2N_HO_Commit.indication primitive, it will have to signal the QoS reservation entity/protocol to immediately establish the radio resources reservation in the access link. As shown in FIG. 9, it is important to mention that the resources reservation procedure is not related with the 802.21 procedures.

Handover Execution

After resource reservation in the target access network, the mobility management procedures may be carried out between the MN and the target access network. This can be done using one of the available mobility management protocols, e.g. Mobile IP (MIP) or Host Identity Protocol (HIP). As a result, the data flow is shifted from the serving to the target access network.

Handover Completion

Finally, the MN sends the MIH_MN_HO_Complete.request message to the target access network to terminate the handover procedure. The target access network exchanges MIH_N2N_HO_Complete messages with the old access network in order to release the resources that were reserved for the MN and power off. To finalize, the successful completion of the handover is reported back to the MN (MIH_MN_HO_Complete.response (Status=success) [MIH_NET_SAP]).

Summarizing, in the current IEEE 802.21 specification, it has been defined how to control lower layers by executing primary (e.g., disconnecting, power-saving, power-on/off) and/or secondary commands (e.g., scanning), but radio resources reservation and deletion at the target and serving access network, respectively, during handover has been left out of scope. This step is important for the whole procedure as it may affect the overall handover delay and consequently the handover user experience. Therefore, new IEEE 802.21 messages are required for efficient management of radio resources at lower layers.

### SUMMARY OF THE INVENTION

The present invention is related to a method for performing radio resource management at lower layers during handover using the IEEE 802.21 framework. The proposed messages extend the currently specified Media Independent Command Service (MICS) by introducing explicit commands for radio resource reservation and deletion. These messages are defined for the MIH_SAP, MIH_LINK_SAP and MIH_NET_SAP.

The present invention uses the format of existing command messages in order to guarantee application in a future extension of the standard.

The present invention is applicable in cases where a MIH User, which manages the network resources, triggers the resource reservation or deletion at lower layers. These actions may be performed either locally or remotely.

The present invention is applicable to QoS enabled access technologies including IEEE 802.16 (WiMAX), IEEE 802.11 implementing the IEEE 802.11e extension and 3GPP networks. It can also apply in cases where an additional level of “intelligence” for resource management exists between the MIH protocol and a non-QoS native L2 technology.

### BRIEF DESCRIPTION OF THE DRAWINGS

FIG. 1: MIH Reference Framework Model

FIG. 2: MIH Architecture

FIG. 3: Local and Remote Events

FIG. 4: Local and Remote Commands

FIG. 5: Information Service (IS) Remote Command

FIG. 6: QoS Thresholds configuration and Measurement Reports

FIG. 7: MIH Information Server Query for Available Candidate Access Networks (CANs)

FIG. 8: Resources Availability Check on the Candidate Access Networks (CANs)

FIG. 9: Resources Allocation on the Target Access Network (TAN)

FIG. 10: Resources release in the previous access network

FIG. 11: MIH commands for link layer resources management

FIG. 12: MIH_Link_Actions.request(QOS_RESERVATION) operation

FIG. 13: MIH_Link_Actions.confirm(QOS_RESERVATION) operation

FIG. 14: Link_Action.request(QOS_RESERVATION) operation

FIG. 15: Link_Action.confirm(QOS_RESERVATION) operation

FIG. 16: Local Resources Allocation on the Target Access Network (TAN) with the proposed MIH enhancements

FIG. 17: Remote Resources Allocation on the Target Access Network (TAN) with the proposed MIH enhancements

FIG. 18: Local Resources Deletion on the Previous Access Network (PAN) with the proposed MIH enhancements

FIG. 19: Remote Resources Deletion on the Previous Access Network (PAN) with the proposed MIH enhancements

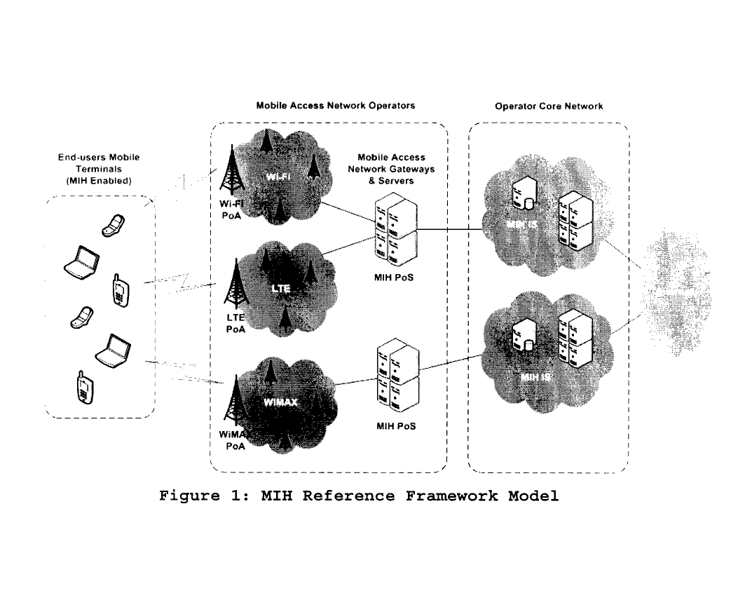

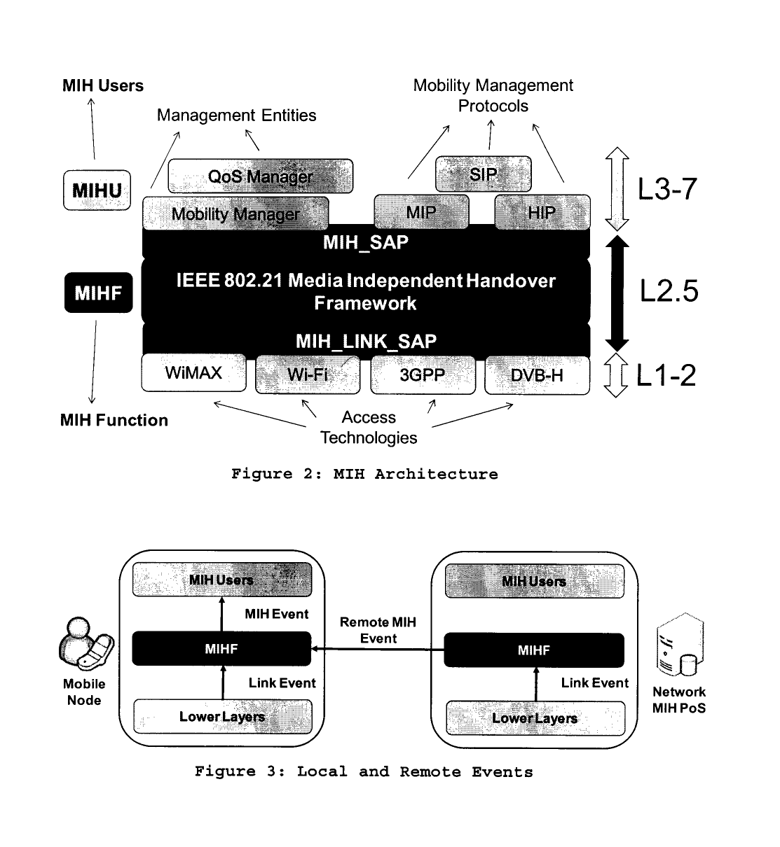

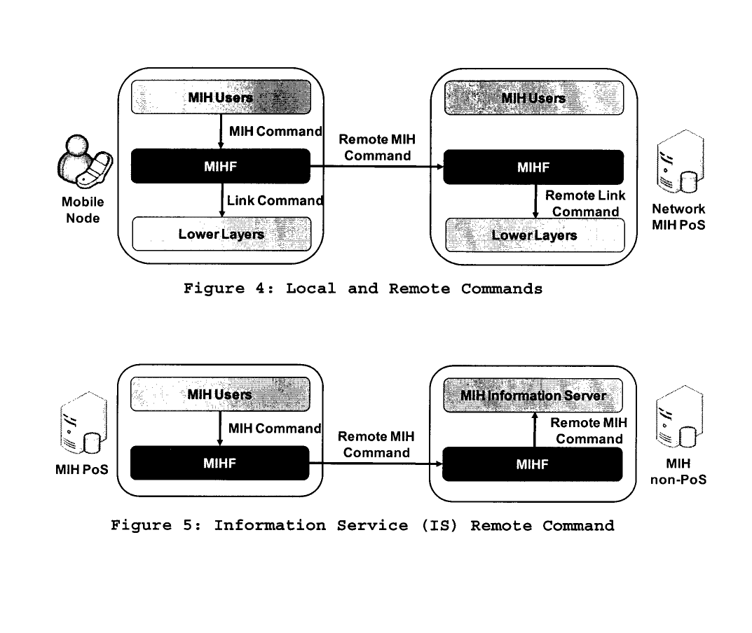

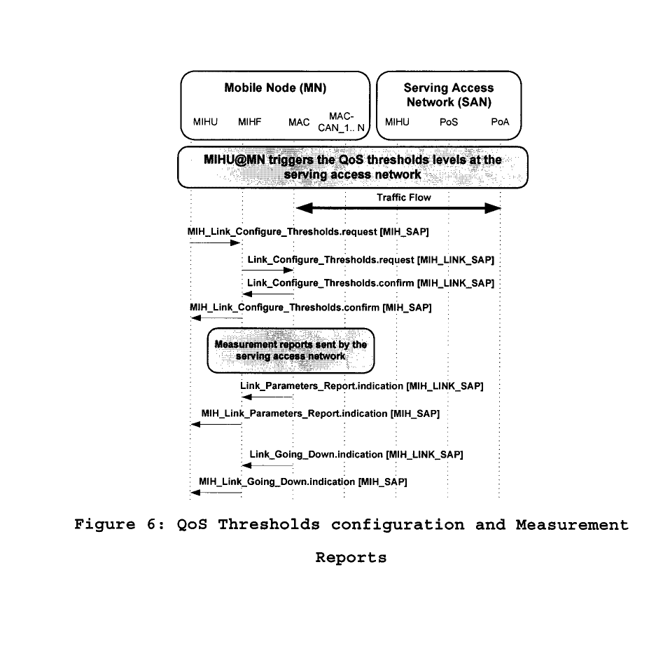

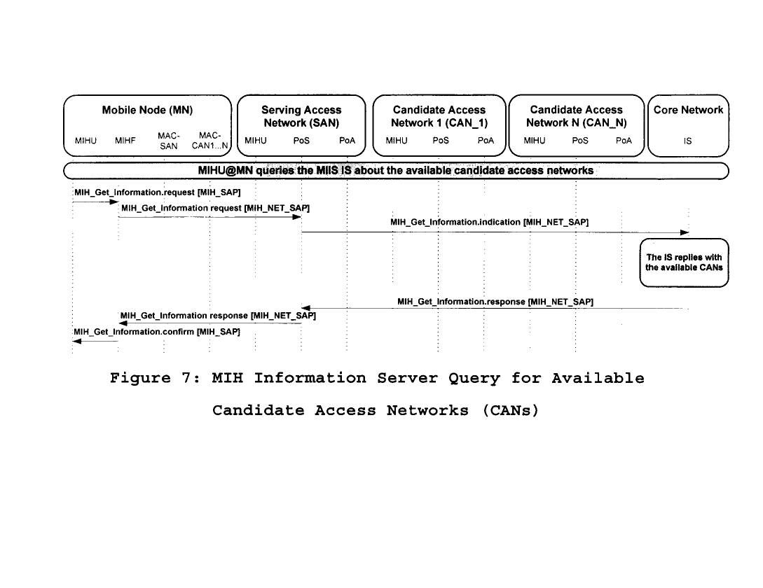

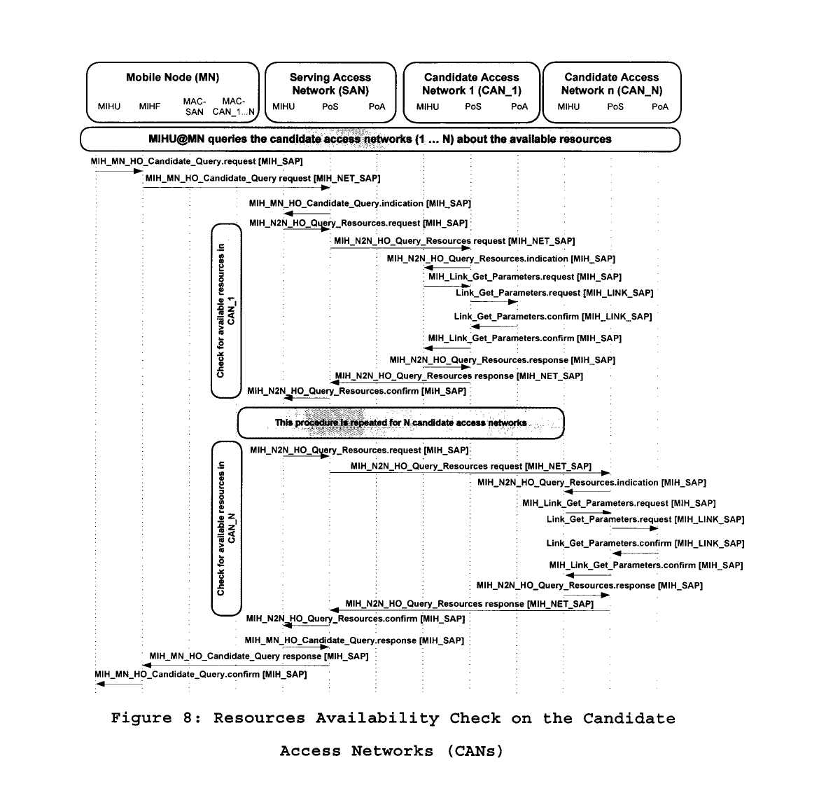

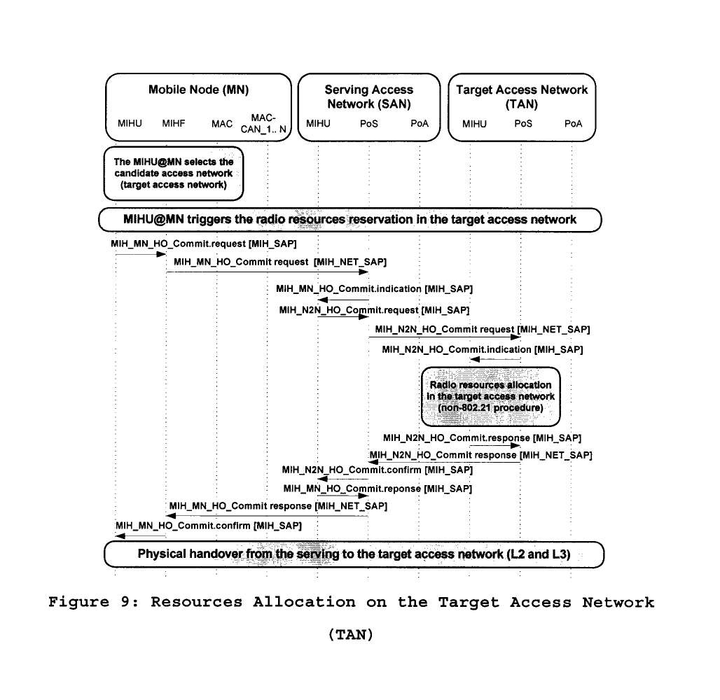

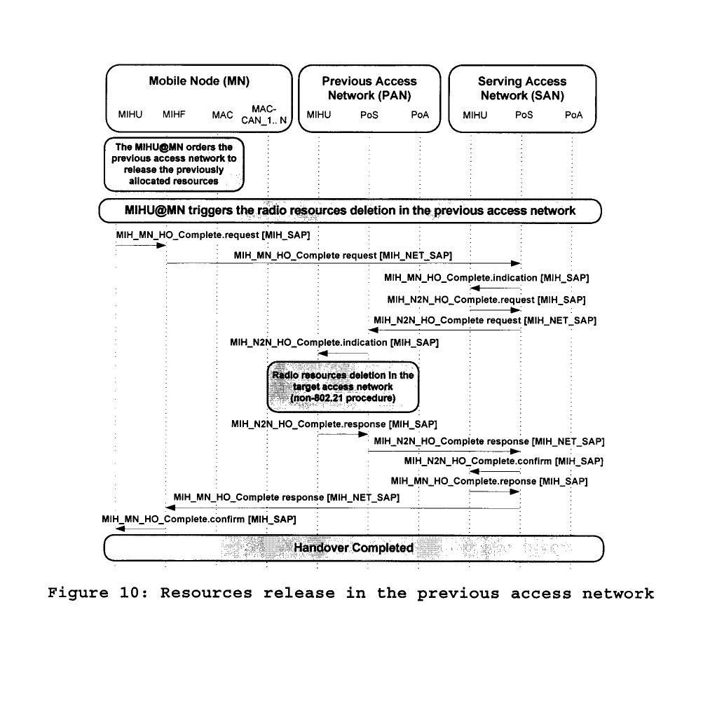

Table 1: MIH commands for link layer resources management

Table 2: MIH_Link_Actions.request service primitive parameters

Table 3: Modified link data types for MIH_Link_Actions.request service primitives

Table 4: Link actions defined for MIH_Link_Actions.request service primitives

Table 6: Modified link data types for MTH_Link_Actions.confirm service primitives

Table 5: MIH_Link_Actions.confirm service primitive

Table 7: Link_Action.request service primitive

Table 8: Link_Action.confirm service primitive

### DETAILED DESCRIPTION

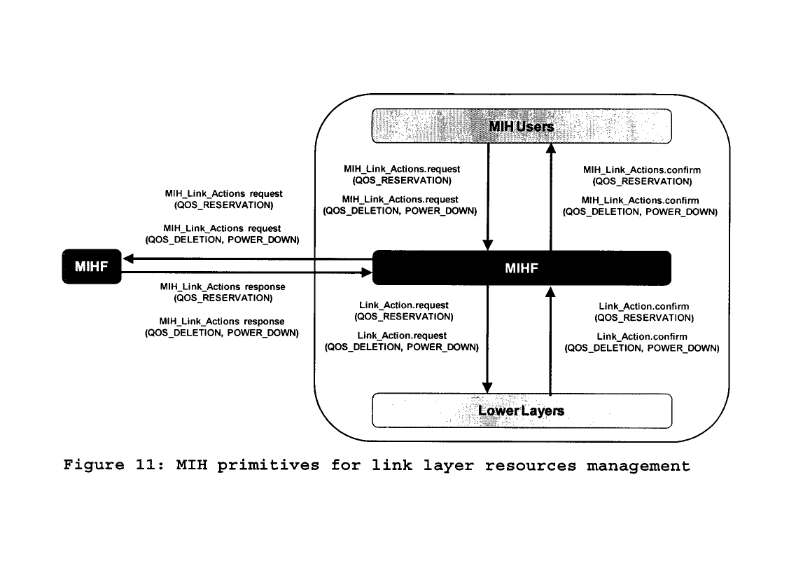

The present invention relates to a method for managing radio resources in the radio access technologies during a handover procedure by proposing new commands for the IEEE 802.21 framework. The proposed IEEE 802.21 primitives, as illustrated in FIG. 11 and Table 1, allow an application level entity, such as a Quality of Service (QoS) Manager or a Mobility Manager, to enforce radio resources allocation and deletion in the link layer, either locally or remotely, as well as to receive notifications from the link layer technologies with the resources reservation and/or deletion result.

### Novel MIH Commands Description

The IEEE 802.21 standard does not provide support for QoS enforcement in the access technologies. This section describes the required enhancements to the IEEE 802.21 standard, specifically in the context of the MIH_SAP, MIH_LINK_SAP and MIH_NET_SAP service primitives, to support QoS reservations and deletions in the access technologies.

MIH_SAP Service Primitive: MIH_Link_Actions

The MIH_Link_Actions service primitives (MIH_Link_Actions.request and MIH_Link_Actions.confirm) define a set of actions to control the access technologies, such as powering down and up the air interface. Two additional actions for the MIH_Link_Actions service primitives are proposed allowing the establishment of a QoS reservation and a QoS deletion in the wireless interface. More details about these primitives and the novel actions are described in the following subsections.
MIH_Link_Actions.request
   Function

This primitive is used by a MIH user to control the benavior of a set of local or remote lower layer links.
Semantics of Service Primitive

The service primitive parameters are described in Table 2.

The relevant link data types for the MIH_Link_Actions.request service primitive enhancements are presented in Table 3.

The actions defined for each action of the MIH_Link_Actions service primitives is illustrated in Table 4.
When Generated

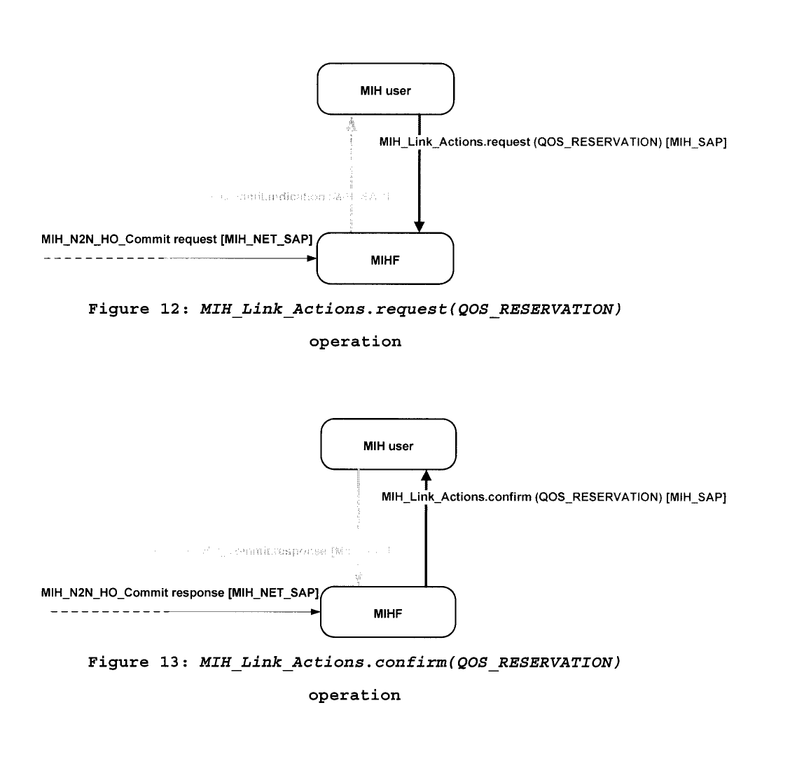

This primitive is invoked by an MIHU when it attempts to control the behaviour of a set of local or remote lower layer links. For QoS management (reservation and deletion) procedures, the MIH_Link_Actions.request(QOS_RESERVATION) and MIH_Link_Action.request(QOS_DELETION, POWER_DOWN) service primitives are triggered when the MIH_N2N_HO_Commit.indication and MIH_N2N_HO_Complete.request service primitives are received by the MIHU, respectively. FIG. 12 illustrates the MIH_Link_Actions.request(QOS_RESERVATION) operation.
Effect on Receipt

If the destination of the request is the local MIHF itself, the local MIHF issues Link_Action.request(QOS_RESERVATION) to the specified lower layer link(s). If the destination of the request is a remote MIHF, the local MIHF generates a MIH_Link_Actions request(QOS_RESERVATION) message to the remote MIHF. Upon the receipt of this message, the remote MIHF then issues Link_Action.request(QOS_RESERVATION) to the specified lower layer link(s).
MIH_Link_Actions.confirm
   Function

This primitive is used by an MIHF to report the result of a MIH_Link_Actions.request message.
Semantics of Service Primitive

The service primitive parameters are described in Table 5.

The relevant link data types for the MIH_Link_Actions.confirm service primitive enhancements are presented in Table 6.
When Generated

This primitive returns the result of a MIH_Link_Actions.request to the requesting MIHU.
Effect on Receipt

Upon receipt of the result, the MIHU makes appropriate evaluations and takes any suitable actions. After receiving the MIH_Link_Actions.confirm (QOS_RESERVATION) or MIH_Link_Actions.confirm(QOS_DELETION, POWER_DOWN) service primitive, the MIHU triggers the MIH_N2N_HO_Commit.response or the MIH_N2N_HO_Complete.reponse service primitives towards the MIHF. FIG. 13 illustrates the MIH_Link_Actions.confirm(QOS_RESERVATION) operation.

MIH_LINK_SAP Service Primitive: Link_Action
Link₋Action.request
   Function

This primitive is used by the MIHF to request an action on a link layer connection to enable optimal handling of link layer resources for the purpose of handovers. The link layer action can be ordered to shut down, remain active, perform a scan, or trigger a QoS reservation or deletion. The command execution delay time can also be specified for cases where the link layer technology under consideration supports the action.
Semantics of Service Primitive

The service primitive parameters are described in Table 7.
When Generated

The MIHF generates this primitive upon request from the MIHU to perform an action on a pre-defined link layer connection.
Effect on Receipt

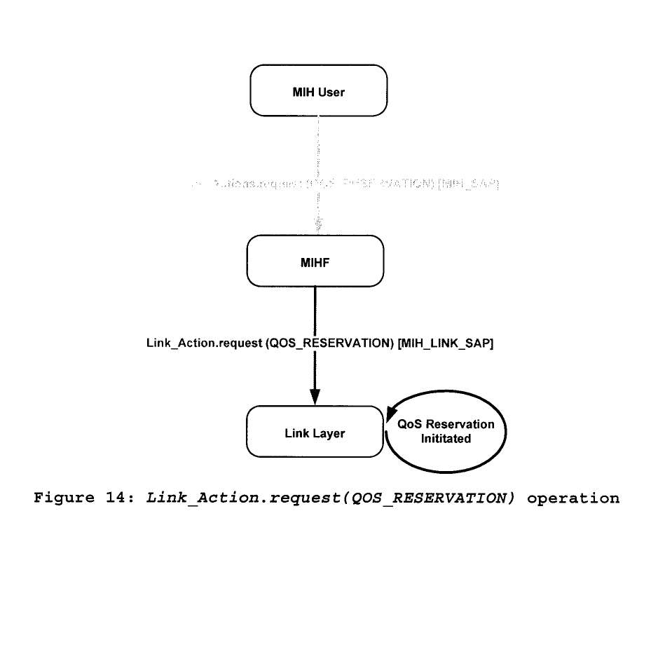

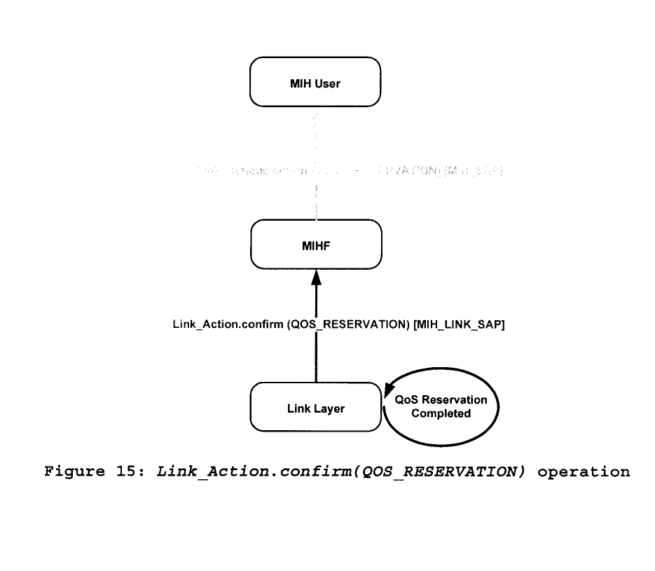

Upon receipt of this primitive, the link layer technology supporting the current link layer connections performs the action specified by the LinkAction parameter and at the time specified by the ExecutionDelay parameter. After receiving the MIH_Link_Actions.request(QOS_RESERVATION) primitive, the MIHF triggers the Link_Action.request(QOS_RESERVATION) primitive towards the link layer, as illustrated in FIG. 14. Thereafter the establishment of the QoS connection on the access technology is triggered.
Link_Action.confirm
   Function

This primitive is used by link layer technologies to provide an indication of the result of the action executed.
Semantics of Service Primitive

The modified service primitive parameters are described in Table 8.
When Generated

The link layer technology generates this primitive to communicate the result of the action executed on the link layer connection.
Effect on Receipt

Upon receipt of this primitive, the MIHF determines the relevant MIH command that needs to be used to provide an indication or confirmation to the MIHU of the actions performed on the current link layer connection. When the QoS reservation is terminated, the Link_Action.confirm(QOS_RESERVATION) service primitive is triggered by link layer towards the MIHF, as depicted in FIG. 15.

Seamless Mobility Procedure Overview with the Proposed MIH Enhancements

Before the physical handover actually happens, a set of operations must be performed to ensure a make-before-break approach. Herein, we will thoroughly depict the details of our innovation, mainly involved in the handover preparation and completion phases.

Local Resources Allocation

After the thresholds configuration during the handover initiation phase, the handover procedure is triggered when the MN indicates a severe degradation in the wireless interface channel conditions [MIH_Link_Configure_Thresholds & MIH_Link_Going_Down]. Thereafter, during the handover preparation phase, the mobility management entities check the available Candidate Access Networks (CAN) surrounding the [MIH_Get_Information], as well as their available resources [MIH_MN_HO_Candidate_Query].

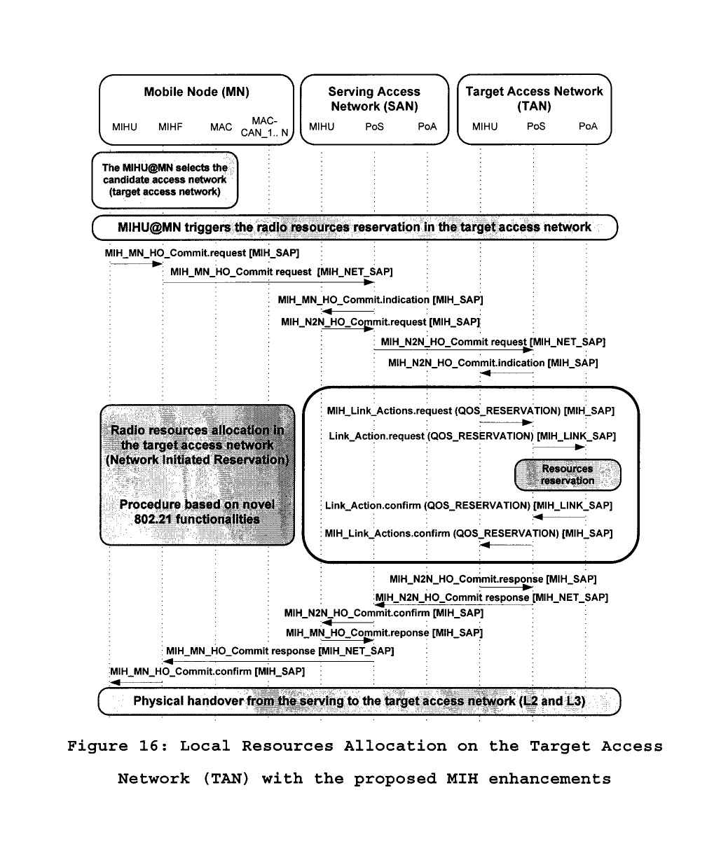

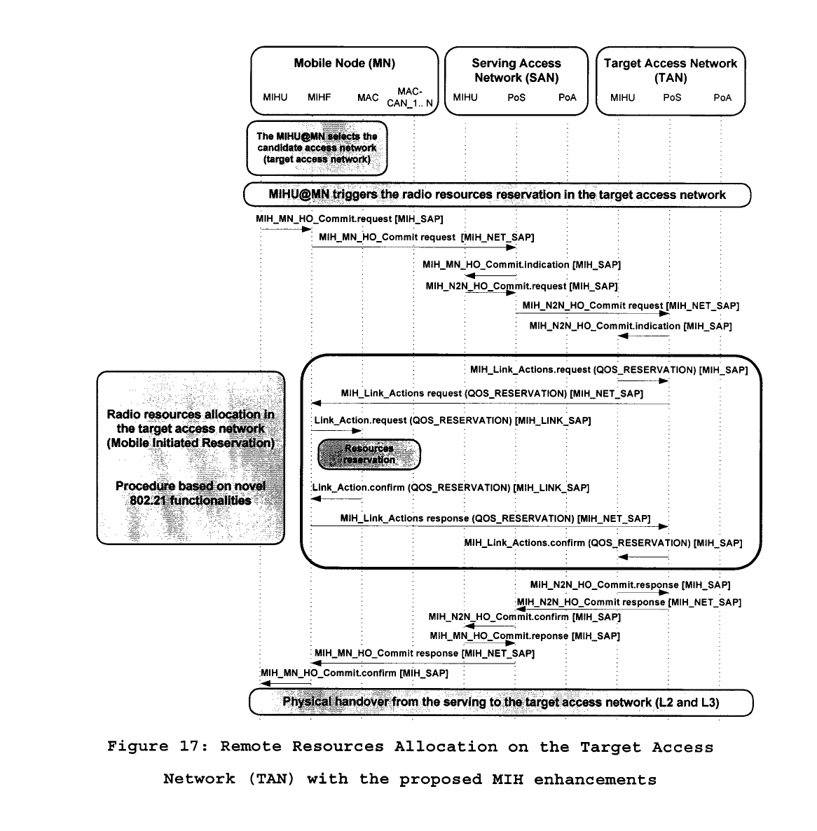

Based on the collected information, the mobility manager selects the Candidate Access Network (CAN) for the handover and powers off the remaining interfaces. Subsequently the radio resources allocation process on the Target Access Network (TAN) is initiated. During this process, the MN sends the MIH_MN_HO_Commit.request message to the Serving Access Network (SAN), which will trigger the MIH_N2N_HO_Commit.request message towards the TAN. Thereafter the MIHU@TAN triggers the resources reservation in the wireless link using the proposed MIH_Link_Actions.request(QOS_RESERVATION) command, as illustrated in FIG. 16, which contains all the required information about the QoS resources that must be allocated.

The MIHF@TAN receives the MIH₋Link_Actions.request(QOS_RESERVATION) and triggers the Link_Action.request(QOS_RESERVATION) command towards the local link layer. After the link layer resources allocation is completed, a report is sent upwards to the MIHF@TAN and to the MIHU@TAN using the Link₋Action.confirm(QOS_RESERVATION) and MIH_Link_Actions.confirm(QOS_RESERVATION) primitives, respectively. This procedure is shown in FIG. 16.

Remote Resources Allocation

For a remote resources allocation procedure, the MIHU@TAN triggers the resources reservation in the wireless link using the proposed MIH_Link_Actions.request(QOS_RESERVATION) command, as illustrated in FIG. 17. Since in this case the resources must be allocated remotely via the MN wireless interface, the MIHF@TAN triggers the MIH_Link_Actions request(QOS_RESERVATION) message to the MIHF@MN through the MIH_NET_SAP interface, which will then be responsible for the local reservation on the wireless link using the Link_Action.request(QOS_RESERVATION) command through the MIH_LINK_SAP.

A report with the allocation process result is sent back to the MIHU@TAN using the Link_Action.confirm(QOS_RESERVATION), MIH_Link_Actions response(QOS_RESERVATION) and the MIH_Link_Actions.confirm(QOS_RESERVATION) primitives. The complete remote resources allocation procedure is illustrated in FIG. 17.

Local Resources Deletion

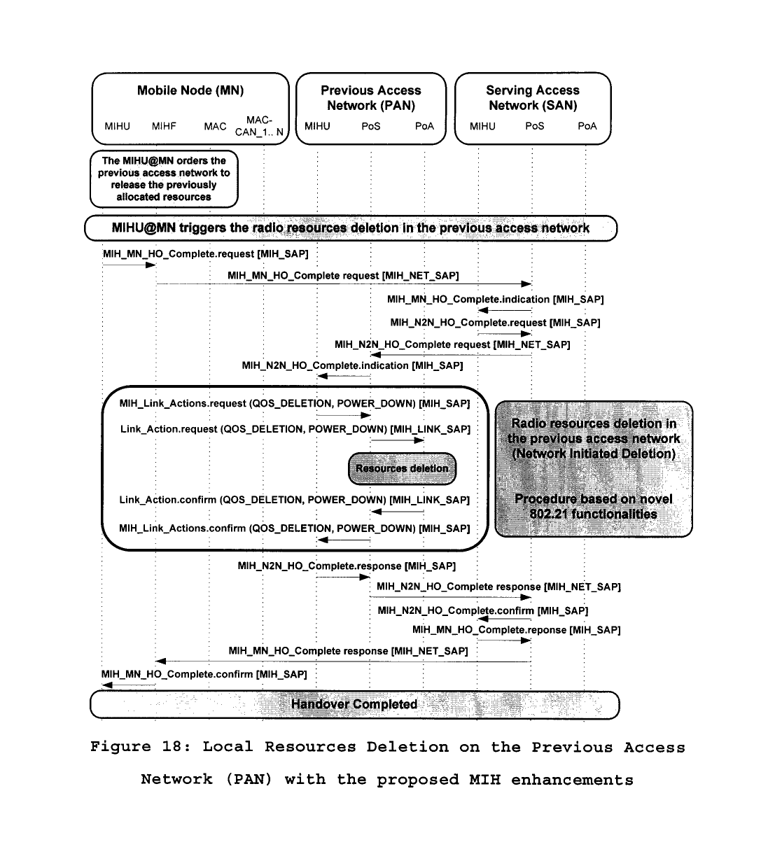

After the MN switches from the previous to the target wireless interface, data starts flowing through the new interface and the resources on the Previous Access Network (PAN) must be released. To release the radio resources on the PAN, the MIHU@MN sends the MIH_MN_HO_Complete.request message towards the new serving access network MIHF; subsequently, the MIHF@SAN sends the MIH_N2N_HO_Complete.request command to the MIHF@PAN, which triggers the resources deletion on the Previous Access Network (PAN) using the proposed MIH_Link_Action.request(QOS_DELETION, POWER_DOWN) command, as illustrated in FIG. 18.

The MIHF@PAN receives the MIH_Link_Actions.request(QOS_DELETION, POWER_DOWN) and triggers the Link_Action.request(QOS_DELETION, POWER_DOWN) command towards the local link layer. After the link layer resources are released, a report is sent upwards to the MIHF@PAN and to the MIHU@PAN using the Link_Action.confirm(QOS_DELETION, POWER_DOWN) and MIH_Link_Actions.confirm(QOS_DELETION, POWER_DOWN) primitives, respectively. This procedure is shown in FIG. 18.

Remote Resources Deletion

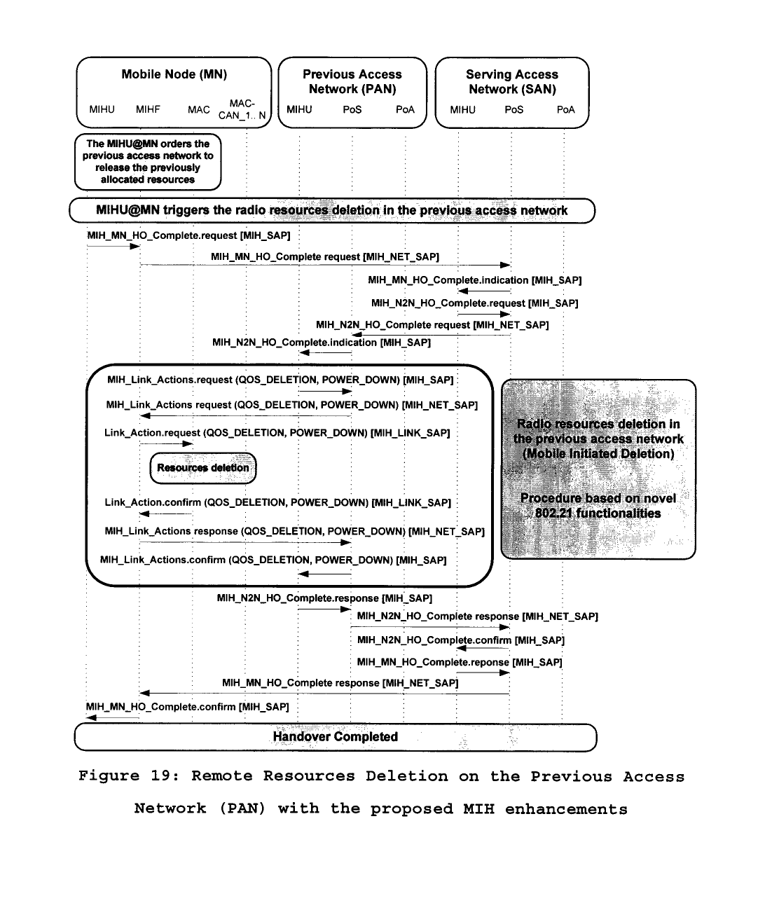

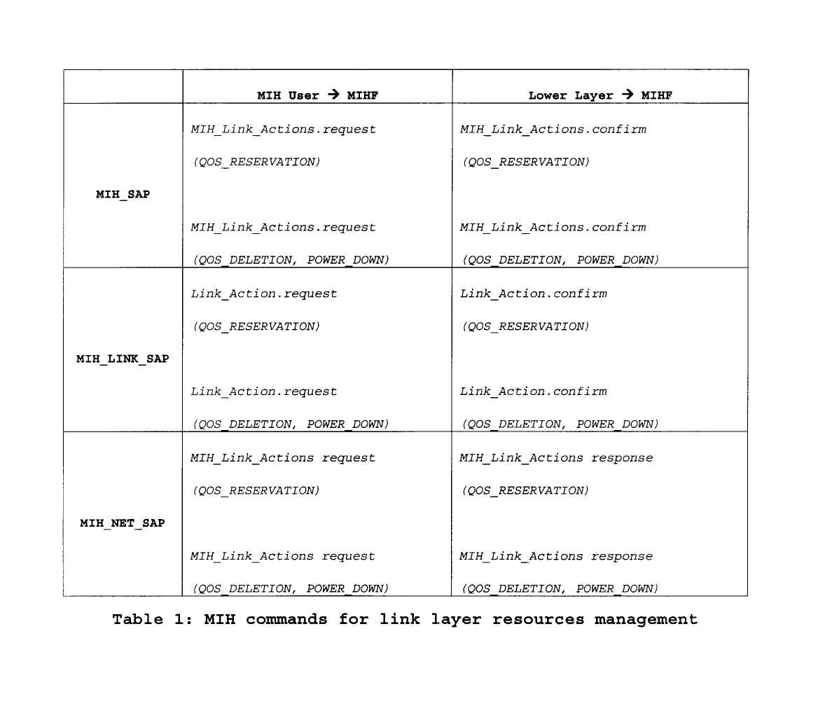

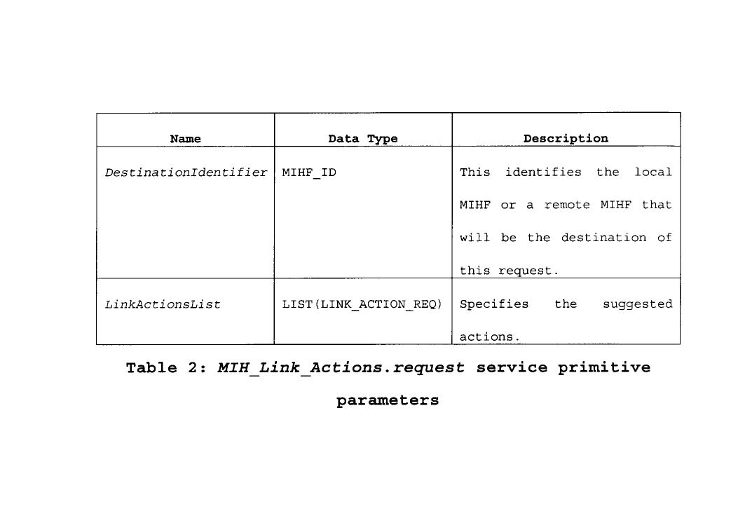

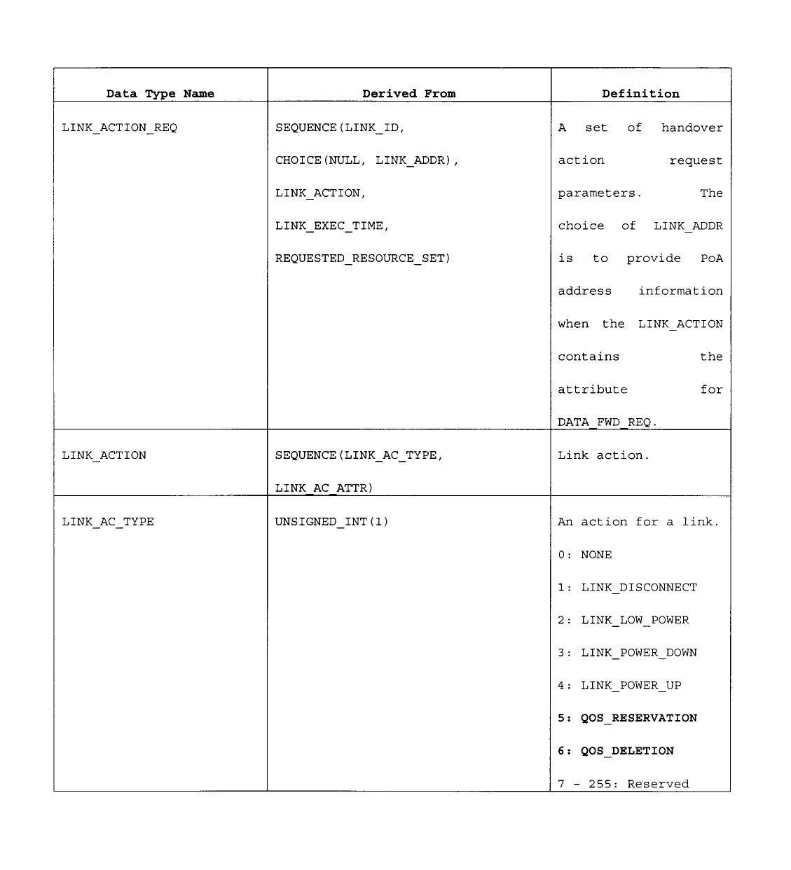

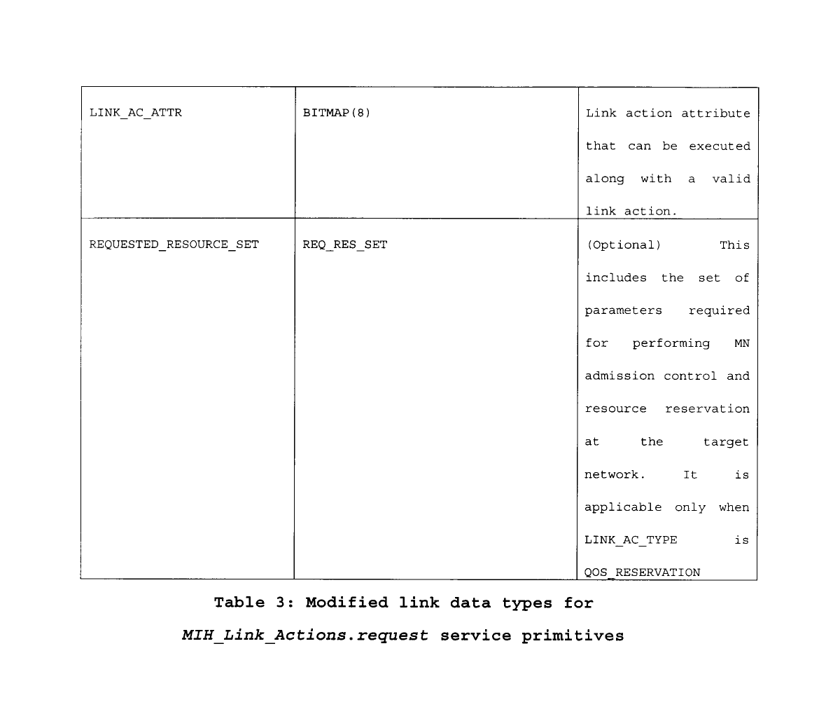

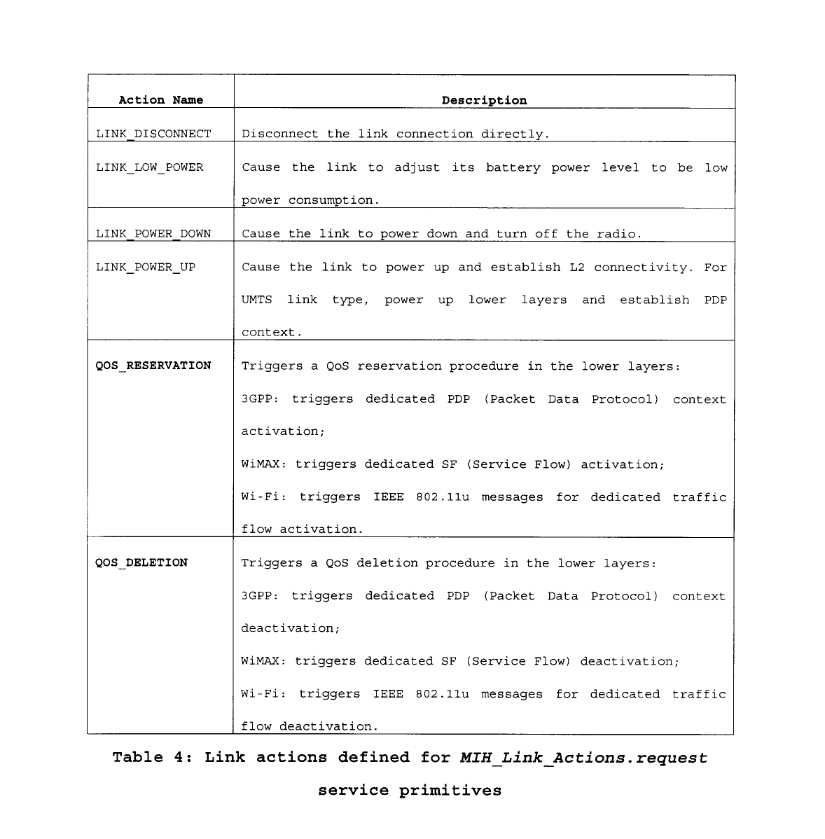

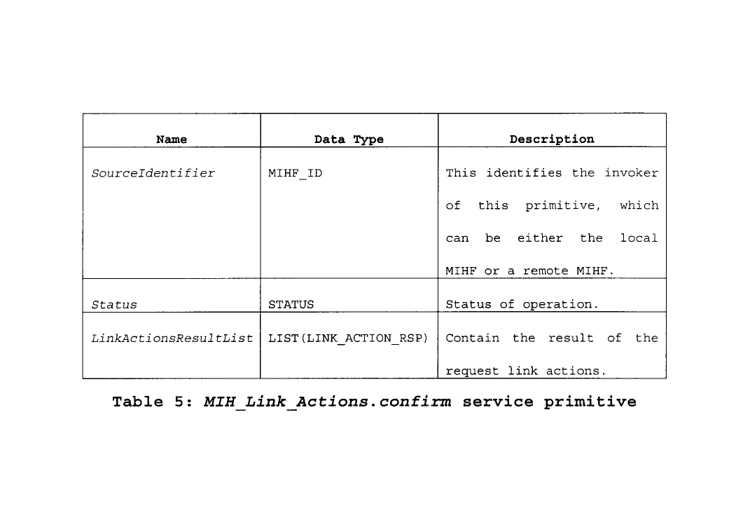

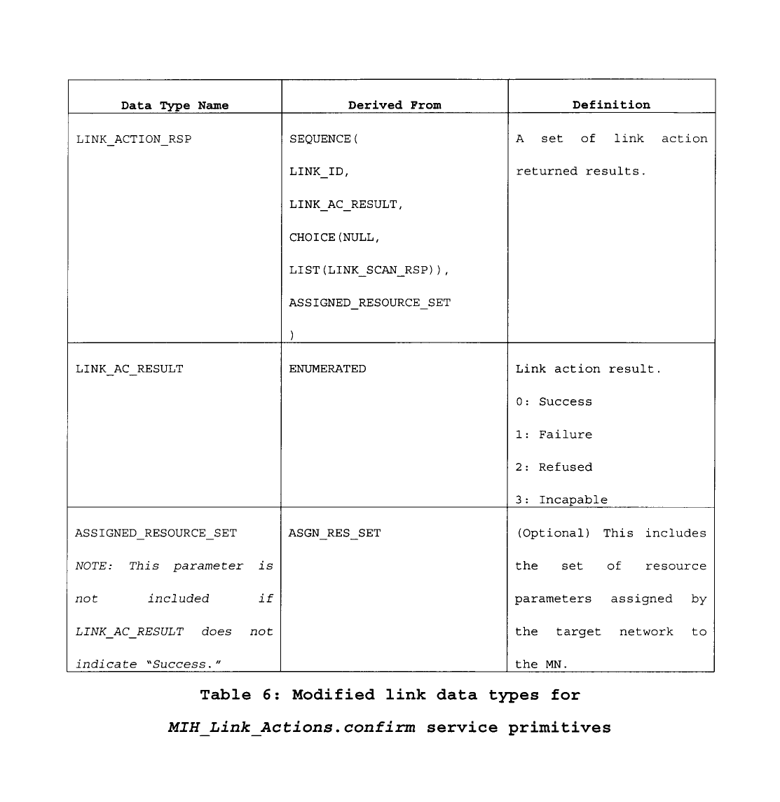

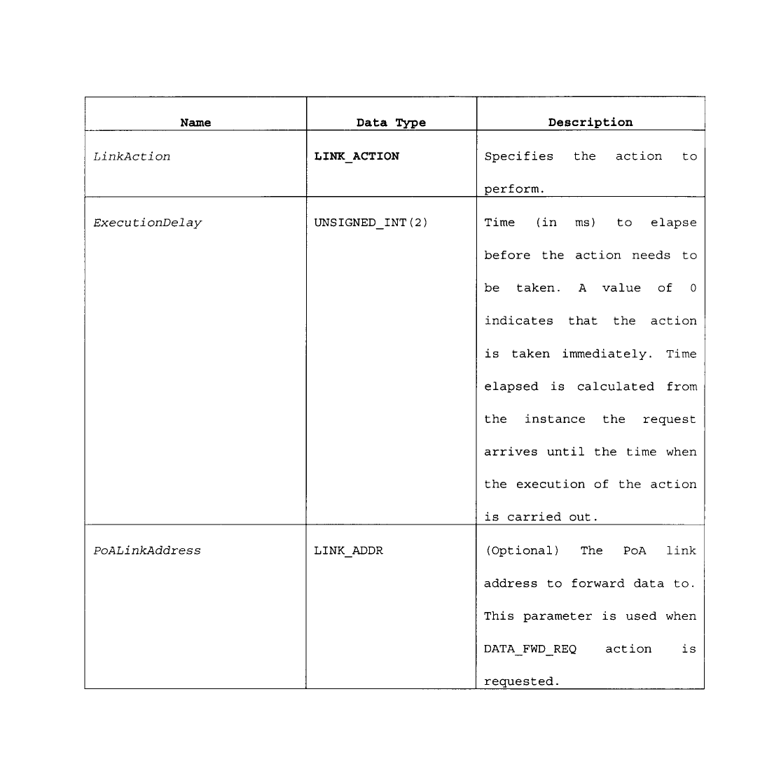

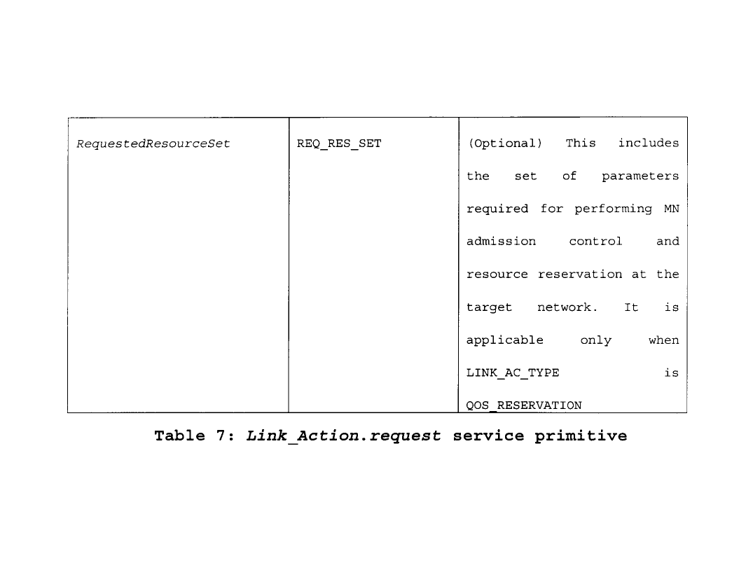

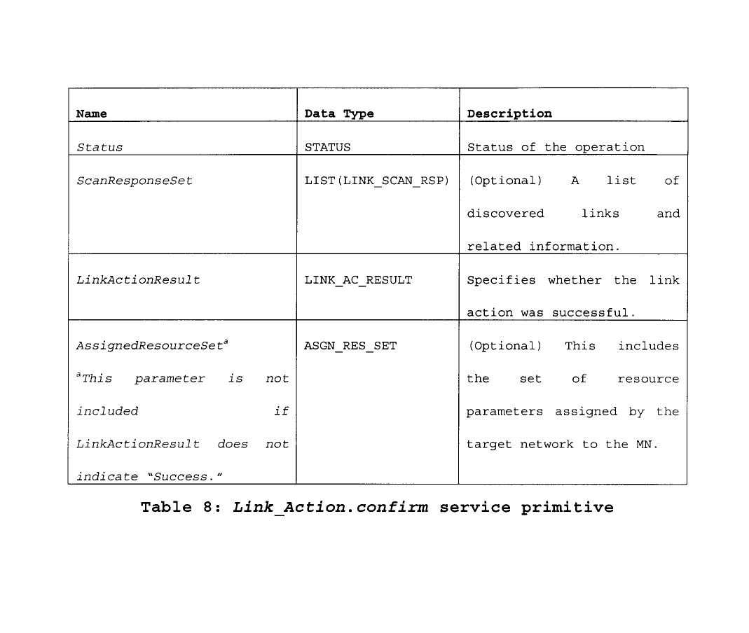

For a remote resources deletion procedure, the MIHU@PAN triggers the resources release in the wireless link using the proposed MIH_Link_Actions.request(QOS_DELETION, POWER_DOWN) command, as illustrated in FIG. 19. Since in this case the resources must be removed remotely via the MN wireless interface, the MIHF@PAN triggers the MIH_Link_Actions request(QOS_DELETION, POWER_DOWN) message to the MIHF@MN through the MIH_NET_SAP interface, which will then be responsible for the resources deletion on the wireless link using the Link_Action.request(QOS_DELETION, POWER_DOWN) command through the MIH_LINK_SAP.

To announce the resources release result, a report is sent back to the MIHU@PAN using the Link_Action.confirm(QOS_DELETION, POWER_DOWN), MIH_Link_Actions response(QOS_DELETION, POWER_DOWN) and the MIH_Link_Actions.confirm(QOS_DELETION, POWER_DOWN) primitives. The complete remote resources allocation procedure is illustrated in FIG. 19.

1. A method for performing radio resource management at lower layers during seamless handover procedures, characterized by using a set of explicit IEEE 802.21 commands for radio resources reservation and deletion on the wireless access technologies, wherein:
the MIH_SAP MIH_Link_Actions.request primitive from the IEEE 802.21 Media Independent Command Service is extended with the QOS_RESERVATION action indicating the required resources to be reserved of the radio access technology;
the MIH_NET_SAP MIH_Link_Actions Request primitive from the IEEE 802.21 Media Independent Command Service is extended with the QOS_RESERVATION action indicating the required resources to be reserved on the radio access technology;
the MIH_LINK_SAP Link_Action.request primitive from the IEEE 802.21 Media Independent Command Service is extended with the QOS_RESERVATION action indicating the required resources to be reserved on the radio access technology;
the MIH_LINK_SAP Link_Action.confirm primitive from the IEEE 802.21 Media Independent Command Service is extended with the QOS_RESERVATION action to communicate the result of the action executed on the link layer connection;
the MIH_NET_SAP MIH_Link_Action Confirm primitive from the IEEE 802.21 Media Independent Command Service is extended with the QOS_RESERVATION action to communicate the result of the action executed on the link layer connection;
the MIH_SAP MIH_Link_Actions.confirm primitive from the IEEE 802.21 Media Independent Command Service is extended with the QOS_RESERVATION action to communicate the result of the action executed on the link layer connection;
the MIH_SAP MIH_Link_Actions.request primitive from the IEEE 802.21 Media Independent Command Service is extended with the QOS_DELETION action indicating the required resources to be deleted on the radio access technology;
the MIH_NET_SAP MIH_Link_Actions Request primitive from the IEEE 802.21 Media Independent Command Service is extended with the QOS_DELETION action indicating the required resources to be deleted on the radio access technology;
the MIH_LINK_SAP Link_Action.request primitive from the IEEE 802.21 Media Independent Command Service is extended wiTh the QOS_DELETION action indicating the required resources to be deleted on the radio access technology;
the MIH_LINK_SAP Link_Action.confirm primitive from the IEEE 802.21 Media Independent Command Service is extended with the QOS_DELETION action to communicate the result of the action executed on the link layer connection;
the MIH_NET_SAP MIH_Link_Action Confirm primitive from the IEEE 802.21 Media Independent Command Service is extended with the QOS_DELETION action to communicate the result of the action executed on the link layer connection;
the MIH_SAP MIH_Link_Actions.confirm primitive from the IEEE 802.21 Media Independent Command Service is extended with the QOS_DELETION action to communicate the result of the action executed on the link layer connection.

2. The method as in claim 1, wherein the reception of the MIH_LINK_SAP Link_Action.request primitive, with the QOS_RESERVATION action, by the 3GPP control layer triggers a 3GPP SMREG-PDP-ACTIVATE primitive to establish a dedicated Packet Data Protocol (PDP) context activation on the 3GPP wireless link.

3. The method as in claim 1, wherein the reception of the MIH_LINK_SAP Link_Action.request primitive, with the QOS_RESERVATION action, by the IEEE 802.16 control layer triggers a IEEE 802.16 C-SFM-REQ (Create) primitive to establish a dedicated SF on the IEEE 802.16 wireless link.

4. The method as in claim 1, wherein the reception of the MIH_LINK_SAP Link_Action.request primitive, with the QOS_RESERVATION action, by the IEEE 802.11 control layer triggers a IEEE 802.11 MSGCF-ESS-Link-Command (QOS_RESERVATION) primitive to establish the required resources on the IEEE 802.11 wireless link.

5. The method as in claim 1, wherein the reception of the MIH_LINK_SAP Link_Action.request primitive, with the QOS_DELETION action, by the 3GPP control layer triggers a 3GPP SMREG-PDP-DEACTIVATE primitive to eliminate the dedicated PDP context on the 3GPP wireless link.

6. The method as in claim 1, wherein the reception of the MIH_LINK_SAP Link_Action.request primitive, with the QOS_DELETION action, by the IEEE 802.16 control layer triggers a IEEE 802.16 C-SFM-REQ (Delete) primitive to eliminate the dedicated SF on the IEEE 802.16 wireless link.

7. The method as in claim 1, wherein the reception of the MIH_LINK_SAP Link_Action.request primitive, with the QOS_DELETION action, by the IEEE 802.11 control layer riggers a IEEE 802.11 MSGCF-ESS-Link-Command (QOS_DELETION) primitive to eliminate the required resources on the IEEE 802.11 wireless link.
